(19) United States
(12) Patent Application Publication
(10) Pub. No.: US 2024/0246088 A1
(43) Pub. Date: Jul. 25, 2024

(54) APPARATUS AND SYSTEM FOR MANUFACTURING NANOCELLULOSE COMPOSITIONS

(71) Applicant: Reenano LLC, Redding, CA (US)

(72) Inventors: Refael Aharon, Ann Arbor, MI (US); Noam Levkovitz, Tel Aviv (IL)

(21) Appl. No.: 18/561,698

(22) PCT Filed: May 13, 2022
(86) PCT No.: PCT/US22/29220

§ 371 Date: Nov. 16, 2023

Related U.S. Application Data
(60) Provisional application No. 63/189,612, filed on May 17, 2021.

(51) Int. Cl. B02C 18/14; B02C 18/16; B02C 18/18; C08L 1/02

(52) U.S. Cl. CPC B02C 18/14; B02C 18/18; C08L 1/02; B02C 2018/147; B02C 2018/162; C08L 2207/20

(57) ABSTRACT

An apparatus for converting cellulose into nanocellulose. The apparatus includes a tank, a motor, and spherical member. The tank has a tank floor. The motor is supported adjacent to the tank. The motor has a motor shaft. The motor shaft has a first end driven by the motor and a second end. The spherical member is connected to the second end of the motor shaft to rotate the spherical member when the motor is energized. The cellulose material is introduced into the tank and drawn between the spherical member and the tank floor to compress the cellulose material in controlled liquid environment.

### CROSS-REFERENCE TO RELATED APPLICATIONS

This application is a U.S. National Stage Application, filed under 35 U.S.C. § 371, of International Patent Application No. PCT/US2022/029220, filed on May 13, 2022, which claims priority to U.S. Provisional Patent Application No. 63/189,612, filed on May 17, 2021, the entireties of which are incorporated herein by reference.

### FIELD OF THE DISCLOSURE

The present disclosure relates generally to systems for producing nanocellulose compositions and more specifically to systems for producing nanocellulose from virgin cellulose material, recycled cellulose material or cellulose rich waste material.

### BACKGROUND

Plant cell walls are complex structures comprised of diverse configurations of interlocking polysaccharides. The cell wall is divided into three different layers: the middle lamella (ML), the primary wall (P), and secondary wall. The ML contains a high amount of lignin and is primarily responsible for binding the neighboring cells. The primary wall is approximately 30-1000 nm thick and contains three main components: cellulose, hemicellulose, and pectin, where cellulose microfibrils (MFs) are arranged crosswise. The secondary cell wall is further divided into three layers.

Cellulose is a well-organized fibrillar arrangement that is primarily responsible for the mechanical strength of plants. Cellulose is one of the most abundant organic compounds derived from plant biomass.

Although cellulose is a crystalline molecule its crystallinity is imperfect, a significant portion of the cellulose structure is less ordered and can be referred to as amorphous. The degree of crystallinity of native cellulose usually ranges from 40% to 70% depending on the origin of the cellulose and the isolation method. The cellulose is present in the form of the microfibrils, which are bound together by lignin and hemicellulose. These microfibrils are made up of tiny cells having width of 10-50 μm. Cellulose is a natural stable polymer, containing a hydrogen bond network, which does not dissolve in common aqueous solvents and does not exhibit a melting point.

Cellulose molecules with at least one dimension in nanoscale (1-100 nm) are referred to as nanocellulose. Nanocellulose synthesis and application has achieved remarkable growth as a polymer reinforcement in order to create high-performance biomaterials. The main reason for increasing interest in nanosized cellulose material is due to the fact that a highly uniform material with enhanced mechanical properties can be achieved by reducing the size of the cellulose fiber. Nanocellulose is considered to be a sustainable material due to its biodegradable nature. The characteristic properties of nanocellulose like crystallinities, surface area, and mechanical properties vary with the extraction methods and processing techniques.

Nanocellulose can be made from recycled or virgin sources or from cellulosic rich solid and liquid waste sources. In terms of being environmentally friendly, large-scale production of nanocellulose using a cellulosic rich solid and liquid waste source, in general, is a better source than virgin cellulose fibers. Fibers comprising cellulose can be found in liquid or solid waste systems, such as municipal liquid and solid waste sources, industrial waste systems and agricultural waste systems.

While systems and methods for treating municipal waste achieve their intended purpose, a new and improved system and method for converting either virgin or recycled pulp (cellulose) into nanocellulose from waste or other sources.

### SUMMARY

An apparatus for converting biomass and biowaste into cellulose and nanocellulose is disclosed, in accordance with an aspect of the present disclosure. The apparatus includes a tank, a motor, and spherical member. The tank has a tank floor. The motor is supported adjacent to the tank. The motor has a motor shaft. The motor shaft has a first end driven by the motor and a second end. The spherical member is connected to the second end of the motor shaft to rotate the spherical member when the motor is energized. The cellulose material is introduced into the tank and drawn between the spherical member and the tank floor to compress the cellulose material.

The apparatus combines biological, mechanical and chemical production processes, which include enzymatic, Alkali, Acid, Oxidation and mechanical treatments. The process can be continuing or in separate stages, fully automated or fully manual.

In accordance with another aspect of the present disclosure, the apparatus further includes a first floor insert disposed between the spherical member and the tank floor. The first floor insert has a surface that matches the shape of a surface of the spherical member and wherein the surface of the first floor insert is disposed a first distance from the surface of the spherical member.

In accordance with yet another aspect of the present disclosure, the first floor insert further includes a first ramp contiguous with the surface of the first floor insert and a second ramp on an opposite side of the surface of the first floor insert.

In accordance with yet another aspect of the present disclosure, the surface of the first floor insert has a plurality of fins disposed at equal intervals over the surface of the first floor insert.

In accordance with yet another aspect of the present disclosure, the apparatus further includes a second floor insert disposed between the spherical member and the tank floor, and the second floor insert has a surface that matches the shape of the surface of the spherical member and the surface of the second floor insert is disposed a second distance from the surface of the spherical member and the second distance is smaller than the first distance.

In accordance with yet another aspect of the present disclosure, the second floor insert further includes a first ramp contiguous with the surface of the second floor insert and a second ramp on an opposite side of the surface of the second floor insert.

In accordance with yet another aspect of the present disclosure, the surface of the second floor insert has a plurality of fins disposed at equal intervals over the surface of the second floor insert.

In accordance with yet another aspect of the present disclosure, the apparatus further includes a plurality of fins disposed at equal intervals over the surface of the spherical member.

In accordance with yet another aspect of the present disclosure, the plurality of fins are disposed horizontally at equal intervals over the surface of the spherical member.

In accordance with yet another aspect of the present disclosure, the plurality of fins are disposed vertically at equal intervals over the surface of the spherical member.

In accordance with still another aspect of the present disclosure, a system for converting cellulose rich waste into nanocellulose compositions is disclosed. The system includes an enclosure, a first processor, a first storage tank, a washer, a dialyzer, a dehydrator, and a dryer. The enclosure has a receptacle for receiving the cellulose and an internal chamber. The first processor is disposed in the internal chamber of the enclosure. The first processor includes a tank in communication with the receptacle and is configured to receive the cellulose and the tank has a tank floor. The motor is supported adjacent to the tank, and the motor has a motor shaft. The motor shaft has a first end driven by the motor and a second end. The spherical member is connected to the second end of the motor shaft to rotate the spherical member when the motor is energized to draw in the cellulose between the spherical member and the tank floor. The first storage tank is in communication with the first processor. The first storage tank is configured to store a first liquid and communicate the first liquid to the tank of the first processor. The washer is in communication with the first processor for receiving the cellulose after the cellulose has been drawn between the spherical member and the tank floor. The dialyzer is in communication with the washer for receiving the cellulose after the cellulose has been washed by the washer and performing a dialyzation on the cellulose. The dehydrator is in communication with the dialyzer for receiving the cellulose after the cellulose has been dialyzed and performing a dehydration process on the cellulose. The dryer is in communication with the dehydrator for receiving the nanocellulose compositions after the cellulose has been dehydrated and performing a drying process on the nanocellulose compositions. The cellulose exits the enclosure through an exit port disposed in the enclosure after the drying process is completed by the dryer.

### BRIEF DESCRIPTION OF THE DRAWINGS

The principles and operations of the systems, apparatuses, and methods according to the present disclosure may be better understood with reference to the drawings, and the following description. These drawings are given for illustrative purposes only and are not meant to be limiting.

FIG. 1 is a perspective view of a processor for converting cellulose into nanocellulose composition, in accordance with an aspect of the present disclosure.

FIG. 2 is an exploded view of the processor of FIG. 1 for converting cellulose into nanocellulose, in accordance with an aspect of the present disclosure.

FIG. 3 is an external side view of the system for converting bio waste material into nanocellulose and cellulose material, in accordance with an aspect of the present disclosure.

FIG. 4 is a plan view of the system for converting cellulosic waste material into nanocellulose composition, in accordance with an aspect of the present disclosure.

FIG. 5 is a side view of the system for converting cellulose material into nanocellulose material powered by a solar panel, in accordance with an aspect of the present disclosure.

FIG. 6 is a schematic diagram of the components of the system for converting cellulose material into nanocellulose material in container size model, in accordance with an exemplary embodiment of the present disclosure.

FIG. 7 is a perspective view of the components of the system for converting cellulose material into nanocellulose material including crushers and processors and multiple process stages, in accordance with an exemplary embodiment of the present disclosure.

FIG. 8 is a perspective view of the processors of the system for converting cellulose material into nanocellulose material, in accordance with an exemplary embodiment of the present disclosure.

FIG. 9 is a perspective view of the processors and liquid storage of the system for converting cellulose material into nanocellulose material, in accordance with an exemplary embodiment of the present disclosure.

FIGS. 10a and 10b are plan views of the processors of the system for converting cellulose material into nanocellulose material, in accordance with an exemplary embodiment of the present disclosure.

FIGS. 11a, 11b and 11c are perspective views of the processor crushing ball, crushing ball blades or fins, flow of material towards the crushing ball of the system for converting cellulose material into nanocellulose material, in accordance with an exemplary embodiment of the present disclosure.

FIG. 12 are perspective views of the processor crushing ball, washer, dryer, dehydrator, and dialyzer components of the system for converting cellulose material into nanocellulose material, in accordance with an exemplary embodiment of the present disclosure.

### DETAILED DESCRIPTION

In the following description, various aspects of the present disclosure will be described. For purposes of explanation, specific configurations and details are set forth in order to provide a thorough understanding of the present disclosure. Furthermore, well known features may be omitted or simplified in order not to obscure the present disclosure.

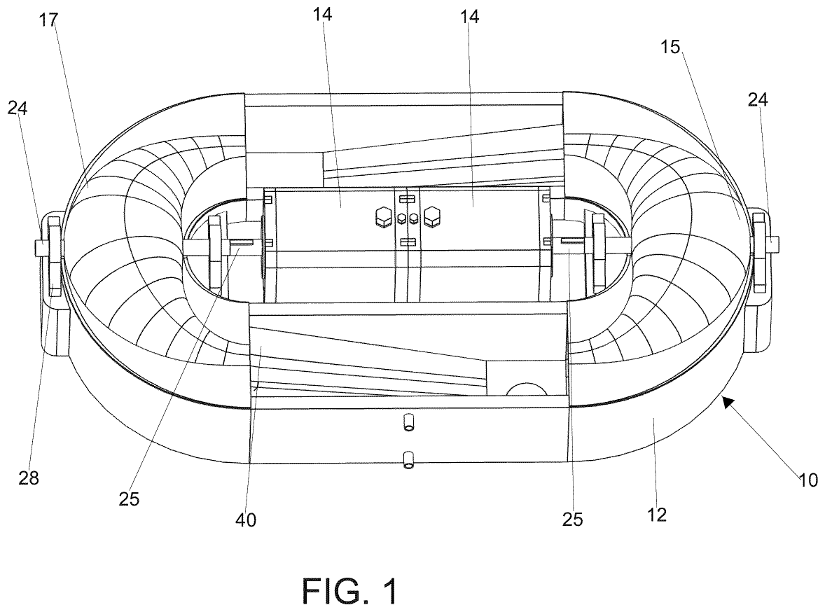

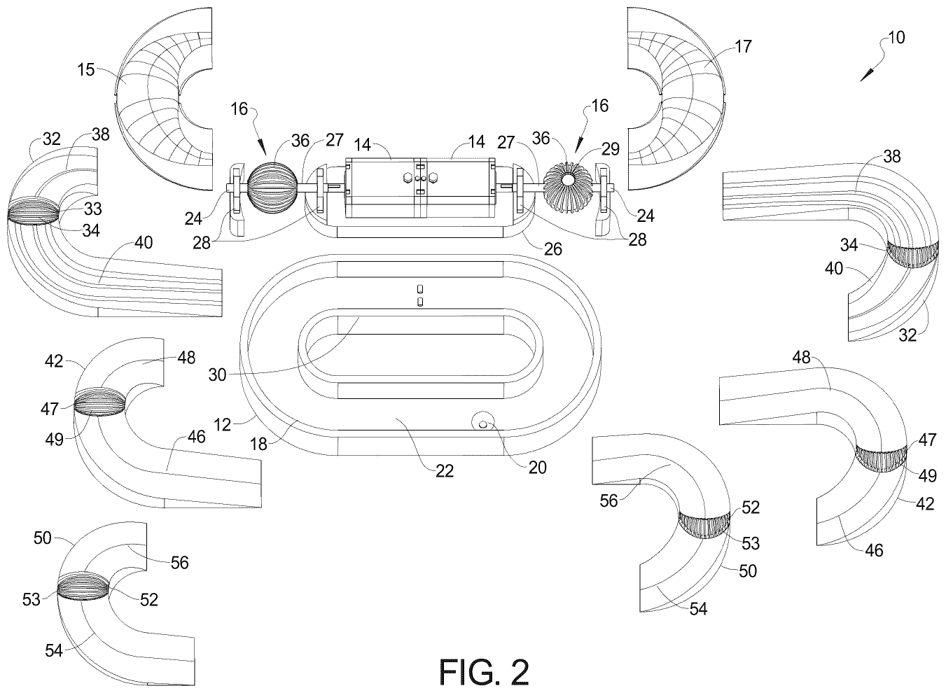

Referring now to FIGS. 1 and 2, a fully assembled perspective view and an exploded view of a processor 10 for converting cellulose material or biomass waste containing cellulose into nanocellulose compositions is illustrated, in accordance with an aspect of the present disclosure. Nanocellulose compositions for the purposes of this disclosure are mixtures of nanocellulose and cellulose and other ingredients. Processor 10 includes a tank 12, a motor 14, a spherical member 16 and a pair of tank covers 15, 17. The tank 12 is an elongated ovular shaped structure having an interior chamber 18. Interior chamber 18 is a watertight chamber that is configured to receive both solids and liquids for converting cellulose material into nanocellulose. Tank 12 further includes a drain 20 for draining or removing liquid and solids for processing in the next stage in the process from the interior chamber 18. Moreover, tank 12 includes a double jacket or heating jacket in contact with an outside surface of the tank. The heating jacket provides temperature control of the tank and the contents of the tank 12. Moreover, tank 12 includes a tank floor 22.

The motor 14 of processor 10 is an electric motor and in an exemplary embodiment is a DC motor. Motor 14 has a motor shaft 24. The motor shaft 24 has a first end 25 driven by the motor 14 and a second end 27. Motor 14 is supported and fixed to a motor platform 26. The motor shaft 24 is supported on motor platform 26 by multiple brackets 28 to allow motor shaft 24 to freely rotate when driven by motor 14. The motor platform 26 is configured to fit and attached to an inner aperture 30 in tank 12.

The spherical member 16 is a ball shape sphere. Spherical member 16 is supported for rotation in the interior chamber 18 of tank 12. Spherical member 16 is made from stainless steel for example. More specifically, spherical member 16 is connected to and supported by motor shaft 24 and brackets 28. The second end 27 of the motor shaft 24 is fixedly attached to the spherical member 16 to rotate the spherical member 16 when the motor 14 is energized. A plurality of fins or blades 29 are disposed at equal intervals over the surface of the spherical member 16. Fins or blades 29 are made of Tungsten, for example, or similar material. In another embodiment of the present disclosure, processor 10 includes more than one spherical member 16, as indicated in FIGS. 1 and 2, where similar or like parts are referenced by like reference numbers. In one example, the plurality of fins 29 are disposed horizontally at equal intervals over the surface of the spherical member 16. In another example, the plurality of fins 29 are disposed vertically at equal intervals over the surface of the spherical member 16.

In an exemplary embodiment, processor 10 further includes a pair of tank covers 15 and 17. Tank covers 15, 17 are configured to cover and enclose at least the area around the spherical member 16. Tank covers 15, 17 function to prevent the cellulose and liquid mixture from leaving the tank 12 of processor 10 through the action or rotation of the spherical members. For example, any part of the cellulose and liquid mixture that contacts the covers 15, 17 is returned to the tank 12.

The cellulose material is introduced into the tank 12 and drawn between the spherical member 16 and the tank floor 22 to compress the cellulose material while in a controlled liquid solution environment. In another embodiment of the present disclosure, a first floor insert 32 is disposed between the spherical member 16 and the tank floor 22. The first floor insert 32 has a surface 34 that matches the shape of the surface 36 of the spherical member 16. The surface 34 of the first floor insert 32 when placed or positioned in the interior chamber 18 of the tank 12 is disposed a first distance from the surface 36 of the spherical member 16. The first floor insert 32 further includes a first ramp 38 contiguous with the surface 34 of the first floor insert 32 and a second ramp 40 on an opposite side of and contiguous with the surface 34 of the first floor insert 32. The first ramp 38 and the second ramp 40 are inclined at an angle that promotes the movement of solids and liquids to flow up or down the ramps and between the spherical member 16 and the surface 34 of the first floor insert 32.

In another embodiment of the present disclosure, the surface 34 of the first floor insert 32 has a plurality of fins 33 disposed at equal intervals over the surface 34 of the first floor insert 32. Fins or blades 33 are made of Tungsten, for example, or similar material. Fins 33 are configured to match the contour or shape of the surface of the spherical member 16.

In yet another embodiment of the present disclosure, the processor 10 has a second floor insert 42 disposed between the spherical member 16 and the tank floor 22. The second floor insert 42 has a surface 44 that matches the shape of the surface of the spherical member 16. The surface 44 of the second floor insert 42 when placed or positioned in the interior chamber 18 of the tank 12 is disposed a second distance from the surface 36 of the spherical member 16. The second distance is smaller than the first distance mentioned above in relation to the first floor insert 32. The second floor insert 42 further includes a first ramp 46 contiguous with a surface 47 of the second floor insert 42 and a second ramp 48 on an opposite side of and contiguous with the surface 44 of the second floor insert 42. The first ramp 46 and the second ramp 48 are inclined at an angle that promotes the movement of solids and liquids to flow up or down the ramps and between the spherical member 16 and the surface 44 of the second floor insert 42. The surface 47 of the second floor insert 42 has a plurality of fins 49 disposed at equal intervals over the surface 47 of the second floor insert 42. Fins 49 are made of Tungsten, for example, or similar material. Fins 49 are configured to match the contour or shape of the surface of the spherical member 16.

In still another embodiment of the present disclosure, the processor 10 has a third floor insert 50 disposed between the spherical member 16 and the tank floor 22. The third floor insert 50 has a surface 52 that matches the shape of the surface of the spherical member 16. The surface 52 of the third floor insert 50 when placed or positioned in the interior chamber 18 of the tank 12 is disposed a third distance from the surface 36 of the spherical member 16. The third distance is smaller than the second distance mentioned above in relation to the second floor insert 42. The third floor insert 50 further includes a first ramp 54 contiguous with the surface 52 of the second floor insert 50 and a second ramp 56 on an opposite side of and contiguous with the surface 52 of the third floor insert 50. The first ramp 54 and the second ramp 56 are inclined at an angle that promotes the movement of solids and liquids to flow up or down the ramps and between the spherical member 16 and the surface 52 of the third floor insert 50. The surface 52 of the third floor insert 50 has a plurality of fins 53 disposed at equal intervals over the surface 52 of the third floor insert 50. Fins 53 are made of Tungsten, for example, or similar material. Fins 53 are configured to match the contour or shape of the surface of the spherical member 16. 33, 42, 57 represents different gaps (distances) between the spherical member 16 and the floor insert.

The present disclosure contemplates that multiple processors 10 may be employed to convert cellulose to nanocellulose compositions with different grades of purity. For example, a system is contemplated where two or more processors 10 are arranged in series where a cellulose waste and liquid mixture is circulated in a first processor and then is communicated to the next or a second processor. A third processor 10 may be arranged in series with the second processor where the cellulose and liquid mixture is transferred from the second processor to the third processor for circulation therein before exiting the third processor as nanocellulose composition.

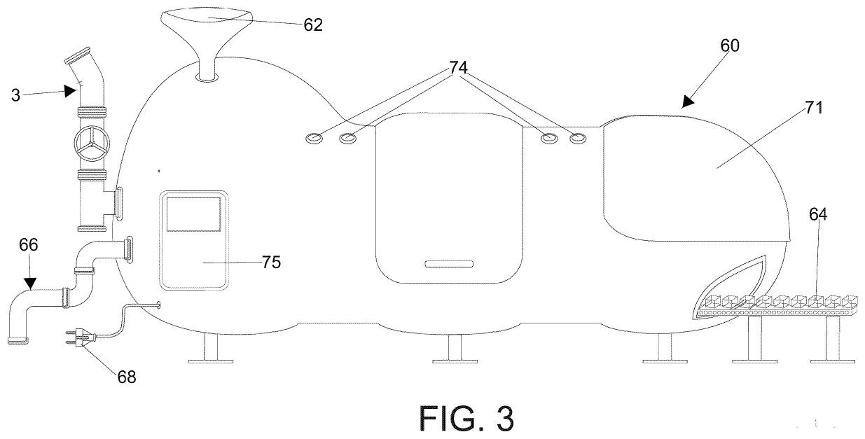

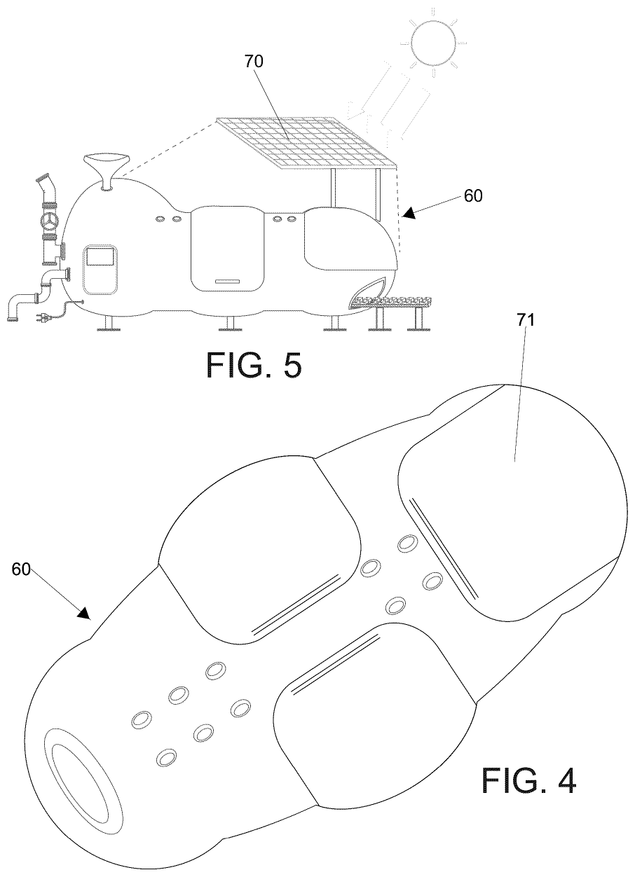

Reference is now made to FIGS. 3 and 4, an external side and plan views of a full system 60 for converting cellulose material into nanocellulose material is illustrated, in accordance with an aspect of the present disclosure. In one exemplary example, cellulosic rich waste material is loaded into the system 60 via a funnel 62. Nano cellulosic composition 64 exits the system 60. The waste produced by system 60 is removed by pipe or conduit 66.

The system 60 is connected to the electrical grid via connector 68 and to a drain (not shown) via pipe 66. In accordance with another aspect of the present disclosure, system 60 may also be powered by a solar panel 70, other alternative energy resources may be considered as well, as shown in FIG. 5.

The internal components of system 60 are accessible through covers or lids 71. Covers or lids 71 are made of metal or similar material. The system 60 includes storage containers that contain liquids used for processing the cellulose material. Each of the liquids are filed and stored separately. The liquids are filled through funnels referenced by reference numeral 74. The liquids may for example be acids, enzymes, water, basis, polymers, and other materials.

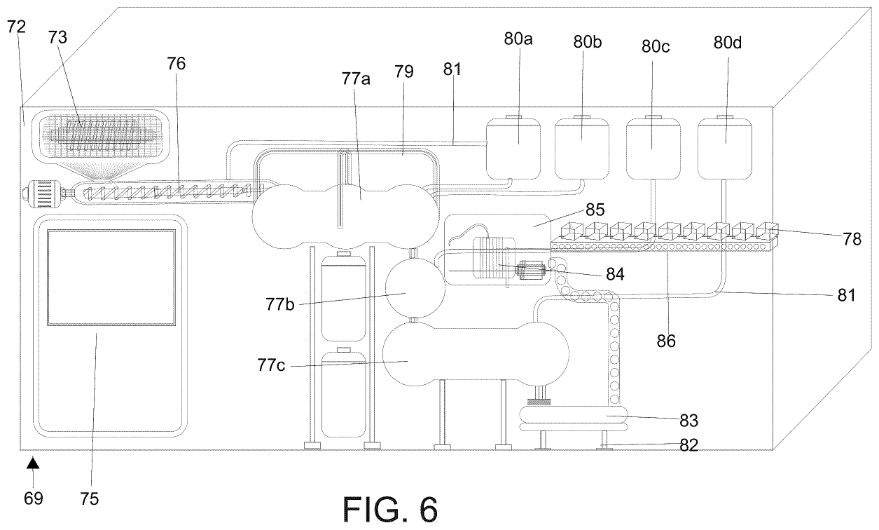

Reference is now made to FIG. 6, a simplified schematic diagram 69 of the components of system 60 is illustrated, in accordance with an exemplary embodiment of the present disclosure. Rich cellulosic waste enters system 60 though input funnel 72 and is converted into a nano cellulosic composition 78, in accordance with an embodiment of the present disclosure. The rich cellulosic waste is, for example, collected from agriculture or other waste resources. The input funnel 72 of system 60 may accept any solid waste content from 1% solid to 99% solid content. The raw material or cellulosic waste is loaded into a crusher 73 by input funnel 72. Crusher 73 breaks down the size of the cellulosic waste into smaller pieces. System 60 is configured to convert virgin and recycled cellulose rich waste into a nano-cellulosic composition 78.

Different system setups and protocols are achieved through artificial intelligence control and electrical panel 75. A conveyor 76 transfers the crushed and downsized cellulosic waste material to a first system processor 77a. Liquids are added to the conveyor 76 to create a solid and liquid mixture. First system processor 77a is similar to the processor 10 described above and shown in FIGS. 1 and 2. First system processor 77a includes round roller or crusher spheres or balls connected to a motor and by a shaft or axel. A support frame 79 fixedly supports the round roller or crusher spheres or balls of the first system processor 77a. The frame 79 can be made from any material that will support the action of the balls or spheres and any vibrations caused by the rotation of the balls and the system weight.

The mixture is transferred in liquid phase (lower than 25% solids) between the first and a second processor 77a, 77b. The mixture is moved between the processors 77a, 77b by gravity or by one or more pumps. The system liquids are stored in containers 80a, 80b, 80c, 80d. The liquids may be in a PH range of 1-14, may contain salts and other solids. The liquids are transferred to the system 60 through conduits or pipes 81. The system 60 includes multiple stands 82 for supporting system 60.

In accordance with an exemplary embodiment of the present disclosure, system 60 may have several processors 77a, 77b. For example, system 60 may have a third processor 77c which may be the last processor in an embodiment of system 60.

The required solid material is collected in tank 83 and transferred by elevator conveyor or other conveyor type to a washer and dryer 84 and dialyzer 85 for washing, dialyzing, dehydrating, drying. After treatment of the solid material by washer and dryer 84 and dialyzer 85 for washing, dialyzing, dehydrating and drying the material is transformed into nano cellulose composite material in the form of gel or powder or liquid or solid 78 and transported by conveyor 86.

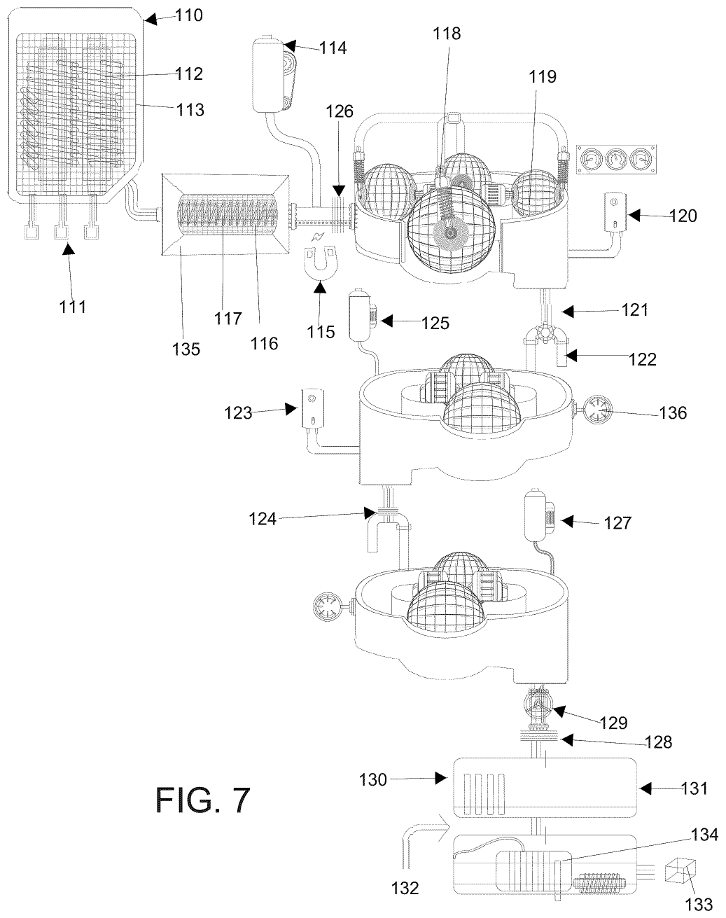

In accordance with another exemplary embodiment of the present disclosure, reference is made to FIG. 7. The raw material entering the system 60 at 110 is analyzed by sensors 111, the material is crushed by 112 and the whole 110 is protected for safety reasons by a net 113. The material is cleaned from metal materials by magnet 115. The conveyor 116 has a heated capacity through a double jacket 135. Liquids and solids may be added from 114 to 117.

The processors 10 or 77a, 77b, 77c have a rotating suspension mechanism 118 and the blades or fins are represented by bolded lines 119 which may be oriented vertically or horizontally. Ultrasonic waves are induced by ultrasonics 126 and the parameters of the liquid and solids (i.e. temperature, viscosity, PH, etc.), are continually monitored by sensor 120. The rotating ball blades and the processor floor 125 match and have exact distance or spacing between them. Cavitation, air bubble, sonication. In the bath there are sensors that monitor the reaction.

The liquid solid mixture is transferred to second processor by conduit 121 having a screen, then automatic valve 122 and 124 can either return the material to first processor or move the next step, based on a protocol. The screen in conduit 121 separates the larger solids form the liquid solid mixture allowing smaller solids and liquids to pass through to the next processor or stage. The process includes temperature changes which are monitored by 136. The particle size is monitored by 127 and after the second processor has completed the material is sized by sizer 128. Liquid and larger material is returned to the second processor. The solids are washed using water or other liquids and monitored by sensors 130 and external or from other processors materials are added and mixed in mixer 131. The washed product 133 is transferred by conduit 132 for dehydration and packaging by dehydration and packaging device 134.

Accordingly, the first upper processor receives the cellulosic rich waste in a large particle size, the processor working in a liquid environment and under ultrasonics 211, the processor reaction is heated by double jacket 214, the crushing balls are held by a suspension system 210. The floor below the crushing ball has a design 215 that matches the ball design but the ball does not touch the floor of the processor.

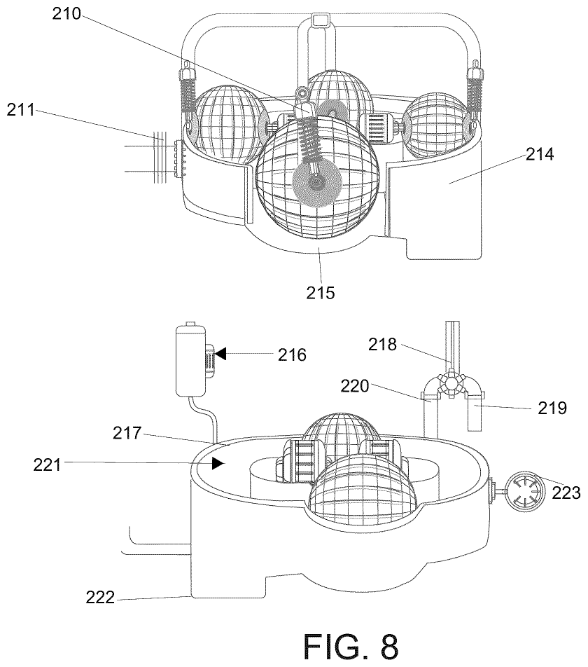

In accordance with another exemplary embodiment of the present disclosure, reference is made to FIG. 8. The processor floor has a slope toward the drainage 213. The liquid from each processor is transferred to the next stage by drainage 213 which is located on the processor floor.

The liquid and solids from the first processor are either moving to the next stage by conduit 220 or by conduit 219 by valve 218. The second processor is well controlled and monitored by sensor 216. The second processor side design and structure is represented by reference numeral 217. The system 60 may have two or more processors. The liquid and solids are held in the channel 221. The liquid and solids mixture from the second processor are transferred to a filtration system that separates the solids from the liquids and then the solids are transferred to another processor or to the washing and dehydration stages via conduit 222. The second processor has its own control and monitor including artificial intelligence 223.

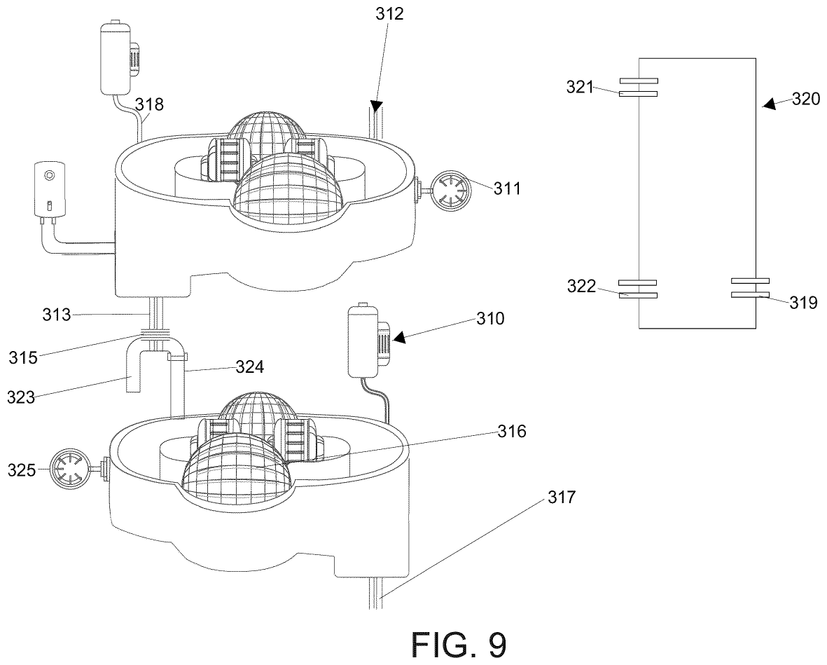

In accordance with still another exemplary embodiment of the present disclosure, reference is made to FIG. 9. Further included are an ultrasonic inducer 312 sensors 318. The system 60 may contain two or more processors, each processor has its own liquid supply and control 311, 310. The liquid is stored in tank 320. Pipe 321 is the refill pipe. Pipes 319 and 322 communicate the liquid to the processors.

The liquid and solid from the second processor are being transferred by conduit 313 to a valve 315 that either sends liquid and solid to the next stage through conduit 324 or back to the reaction or spare tank through conduit 323 having a screen.

The third processor has a drainage 317. The third crusher lines of blades 316 are oriented horizontally on a first crusher ball and one vertically on a second crusher ball.

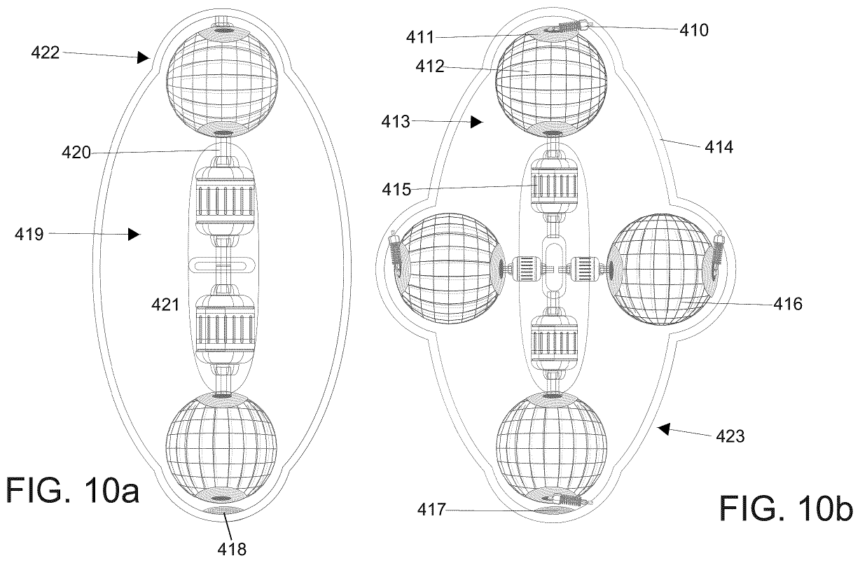

In accordance with yet another exemplary embodiment of the present disclosure, reference is made to FIGS. 10a and 10b. More specifically, the first processor includes suspension and vibration system 410, crusher 411 is the holder, and 412 and 416 are the crusher lines or blades. The processor has a processor floor 413. The crusher 411 has a crusher axel 414. Crusher axel 414 driven by a motor 415 which makes the crusher roll. The processor has a processor drainage 417. The first processor has sensor's location 423. The second and third processors have one set of parallel crushers motor 421, sensors 422 and drainage 418. The second processor floor 419 is smooth in the non-crushing parts.

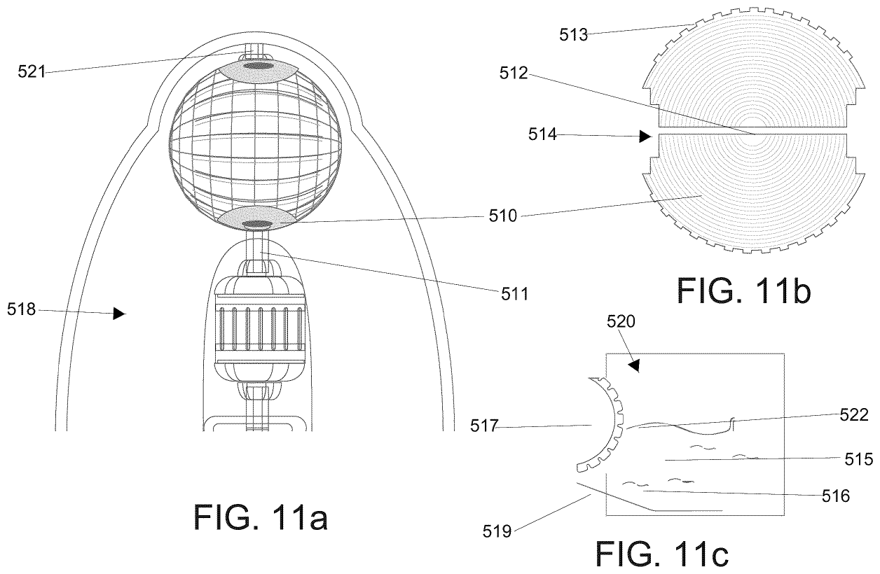

In accordance with yet another exemplary embodiment of the present disclosure, reference is made to FIGS. 11a and 11b. The crushing balls lines, fins or blades 513 are made from corrosion and physical resistant material such as tungsten, iron, platinum, stainless still, composite materials and polymers. The crushing disk 510 has hole 512 for the axel 511, the disk has a gap 514 that is adapted to the processor body. The crusher ball 517 is in liquid 516 and solids 515, the average liquid level 522 is maintained by connected vessel principle.

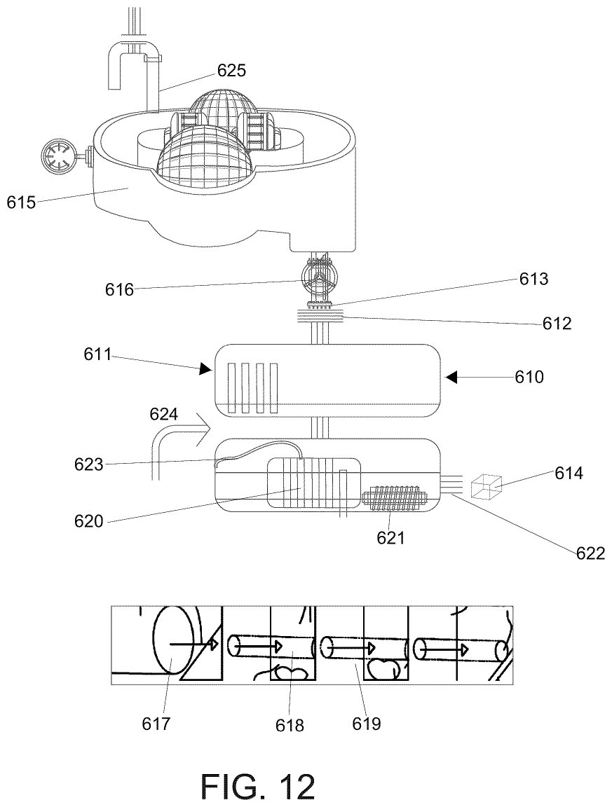

In accordance with yet another exemplary embodiment of the present disclosure, reference is made to FIG. 12. The last processor 625 ends activity according to the protocol when ready according to sensors and control 615. The automatic valve 616 is opened and the liquid and solids mixture goes through screens 612 and 613 that capture the bigger material particles which then returned to the prior processor, the smaller particles pass through screens 612 and 613 to the washer or washing stage 610. The initial volume of the mixture 617 is reduced by reverse osmosis and dehydration to 618 and 619.

The washing stage includes as an example dialyzer and reverse osmosis 611, the final product is transferred to the dehydration stage 620, vapors are evaporated by 623. Mixture of additional material and further oven dehydration 621 converts the product into solid form. The nano cellulosic product 614 is transferred by conveyor 622. The composition produced from liquid and solid waste resources may be nano cellulosic composition comprising a high cellulosic content. The composition produced from liquid and solid waste resources may be nano cellulosic composition comprising a high polymer or other material content. Nano Cellulosic composition may be used to manufacture a range of materials. In a non-limiting example, a yield of 1 dry ton of cellulose waste will produce 35-65% of Nano cellulosic material.

Reference is made to FIGS. 6 and 7, a schematic illustration of the liquid and solid waste conversion system 60 is shown. As shown in FIG. 6, the liquid and solid waste resources may flow into an entrance of crusher 73 or by any other suitable means. Further as shown in FIG. 6, the material from the crusher 73 enters the processor via conveyor 76 or by any other suitable means. The quantity of the final product 78 depends on the waste composition and environmental parameters. The protocols optimize the product quality based on the application. In some protocols, the system 60 may have only two processors. Some protocols are for virgin cellulose waste and others are for recycled waste. The system 60 may include devices for removing other unneeded small particles, such as dirt, dust, rocks, metals and plastic particles.

The crushing balls 118 may be formed in any suitable configuration and may be formed of any suitable material such as a corrosive resistive material and/or a high-pressure resistive material. The number of crushing balls in the processor 118 may vary. The minimum number of balls is one per processor. A residual, substantially liquid portion, is discharged from the processor 214 via an outlet 212 or any suitable means. In some protocols, the liquid portion may be discarded to a storage/recycling tank or may be flow to the next step. In some protocols, the solid particles of the solid portion separated from the liquid portion are in a size range of approximately 0.0001 microns-100 mm. In some protocols, the solid particles of the solid portion separated from the liquid portion are in a size range of approximately 1-1000 nm. It is noted that the term “size” described throughout the disclosure may include any applicable parameter, such as a particle length or a particle diameter, for example. In some protocols, the dryness temp is approximately 30-5000C. The dryness time depends on the temp, pressure and other parameters. The dryness degree of the dehydration device 85 is approximately 5-20%. In some protocols, the solid portion exiting the dehydration device 85, may be introduced into a gel or powder form (+90% dry). Mechanical dehydration (pressure, centrifuge) may also be utilized, for example.

In some protocols, a sensor 422 may be placed at the processor or any other suitable location for monitoring the physical and chemical parameters of the reaction. When the solid portion is below the needed length and quality the operation of the processor continue. In some protocols, the solid portion may be introduced into the composition mixing container prior to entering the dehydration process 85. The sensors may be optical or infrared and work from a distance. Additional devices may be included in system. For example, the raw material may be introduced into a sterilizing device (not shown) for sterilizing the solid portion. The sterilizing device may employ any suitable method for sterilizing the raw material, such as steam sterilization, UV sterilization and use of a chemical reagent for sterilization, for example. Alternatively, the raw material may be partially sterilized, such as by being introduced into a pasteurization device. The system 60 may include a sand removal device (not shown) for removal of sand and stones. During the process fats, ash and salts will be removed, therefrom, by any suitable means. Large iron parts may be removed by any suitable means, such as by utilizing a magnet 115 which attracts the iron thereto thus removing a portion of the iron from entering the system 60.

Control functionality as well as data collecting, and processing functionality may be embodied in processors and electronic circuit boards or any other suitable controller 75 of the system 60. The controller 75 may control various parameters of the operation. Sensors may be placed within the system and may communicate with the controller 75 for controlling the operation of the system 60. For example, one sensor is a PH sensor, and another sensor is a temperature sensor 423. It is noted that besides the sensors described herein, additional sensors or other control elements and electrical connections may be provided for producing the nano cellulosic material.

Controlling the quantity of the cellulosic waste entering the system 60 is done by weight and optical sensors 111. The system may comprise a heating assembly (not shown). The heating assembly may provide heat in any suitable manner. The legs 82 may be configured with adjustable screws for height adjustability thereof. All the system 60 components may be manufactured from metals, steel, glass, plastic, wood or any other composite material.

A skilled artisan will appreciate that in the process of waste conversion some of the devices described hereinabove may be obviated or the order of operating the devices within system 60 may be altered, without compromising the quality of the production of the nano cellulosic composition.

Example protocols of the devices, systems and methods have been described herein. As may be noted elsewhere, these protocols have been described for illustrative purposes only and are not limiting. Other protocols are possible and are covered by the disclosure, which will be apparent from the teachings contained herein. Thus, the breadth and scope of the disclosure should not be limited by any of the above-described protocols but should be defined only in accordance with claims supported by the present disclosure and their equivalents.

1. An apparatus for converting cellulose waste into cellulose and nanocellulose composition, the apparatus comprising:
a tank having a tank floor and a heating jacket contacting an outside surface of the tank, wherein the heating jacket is configured to heat the tank;
a motor supported adjacent to the tank, wherein the motor has a motor shaft, and wherein the motor shaft has a first end driven by the motor and a second end;
a spherical member connected to the second end of the motor shaft to rotate the spherical member when the motor is energized; and
wherein the cellulose waste is introduced into the tank and drawn between the spherical member and the tank floor to compress the cellulose waste.

2. The apparatus of claim 1, further comprising a first floor insert disposed between the spherical member and the tank floor, wherein the first floor insert has a surface that matches the shape of a surface of the spherical member and wherein the surface of the first floor insert is disposed a first distance from the surface of the spherical member.

3. The apparatus of claim 2, wherein the first floor insert further comprises a first ramp contiguous with the surface of the first floor insert and a second ramp on an opposite side of the surface of the first floor insert.

4. The apparatus of claim 2, wherein the surface of the first floor insert has a plurality of fins disposed at equal intervals over the surface of the first floor insert.

5. The apparatus of claim 2, further comprising a second floor insert disposed between the spherical member and the tank floor, wherein the second floor insert has a surface that matches the shape of the surface of the spherical member and wherein the surface of the second floor insert is disposed a second distance from the surface of the spherical member and wherein the second distance is smaller than the first distance.

6. The apparatus of claim 5, wherein the second floor insert further comprises a first ramp contiguous with the surface of the second floor insert and a second ramp on an opposite side of the surface of the second floor insert.

7. The apparatus of claim 5, wherein the surface of the second floor insert has a plurality of fins disposed at equal intervals over the surface of the second floor insert.

8. The apparatus of claim 1, further comprising a plurality of fins disposed at equal intervals over a surface of the spherical member.

9. The apparatus of claim 8, wherein the plurality of fins are disposed horizontally at equal intervals over the surface of the spherical member.

10. The apparatus of claim 8, wherein the plurality of fins are disposed vertically at equal intervals over the surface of the spherical member.

11. A system for converting cellulose waste into cellulose and nanocellulose composition, the system comprising:
an enclosure having a receptacle for receiving the cellulose waste and wherein the enclosure has an internal chamber;
a first processor disposed in the internal chamber of the enclosure, wherein the first processor includes:
a tank in communication with the receptacle and configured to receive the cellulose waste and wherein the tank has a tank floor;
a motor supported adjacent to the tank, wherein the motor has a motor shaft, and wherein the motor shaft has a first end driven by the motor and a second end; and
a spherical member connected to the second end of the motor shaft to rotate the spherical member when the motor is energized to draw in the cellulose waste between the spherical member and the tank floor; and
wherein the cellulose waste is compressed between a surface of the spherical member and the tank floor when the cellulose waste is drawn in between the spherical member and the tank floor, and wherein the cellulose exits the enclosure through an exit port disposed in the enclosure.

12. The system of claim 11, further comprising a first storage tank in communication with the first processor, wherein the first storage tank is configured to store a first liquid and communicate the first liquid to the tank of the first processor to create a cellulose waste and liquid mixture, wherein the mixture includes solids and liquid.

13. The system of claim 12, further comprising a washer in communication with the first processor for receiving the mixture after the mixture has been drawn between the spherical member and the tank floor and passes through a screen.

14. The system of claim 13, further comprising a dialyzer in communication with the first processor for receiving the mixture after the mixture has been drawn between the spherical member and the tank floor and performing a dialyzation on the mixture.

15. The system of claim 14, further comprising a dehydrator in communication with the first processor for receiving the mixture after the mixture has been drawn between the spherical member and the tank floor and performing a dehydration process on the mixture.

16. The system of claim 15, further comprising a dryer in communication with the first processor for receiving the mixture after the mixture has been drawn between the spherical member and the tank floor and performing a drying process on the mixture.

17. The system of claim 12, further comprising a second processor in communication with the first processor for receiving the mixture after the mixture has been drawn between the spherical member and the tank floor and a first screen thereby separating solids and liquids in the mixture.

18. The system of claim 17, further comprising a third processor in communication with the second processor for receiving the mixture after the mixture has been drawn between the spherical member and the tank floor and a second screen thereby separating solids and liquids in the mixture.

19. The system of claim 11, wherein the spherical member further comprises a plurality of fins disposed at equal intervals over the surface of the spherical member.

20. The system of claim 11, wherein the tank floor has a surface opposing the spherical member wherein the surface of the tank floor further comprises a plurality of fins disposed at equal intervals over the surface of the tank floor.
